(19) United States
(12) Patent Application Publication
(10) Pub. No.: US 2023/0376813 A1
(43) Pub. Date: Nov. 23, 2023

(54) GENERATING RANDOMNESS IN DISTRIBUTED AND TRUSTLESS SETTINGS

(71) Applicant: Seagate Technology LLC, Fremont, CA (US)

(72) Inventor: Vipin Singh SEHRAWAT, Fremont, CA (US)

(21) Appl. No.: 17/748,948

(22) Filed: May 19, 2022

(51) Int. Cl. G06N 10/20; G06F 7/58

(52) U.S. Cl. CPC G06N 10/20; G06F 7/588

(57) ABSTRACT

Generation of randomness (e.g., a random value) using a protocol based on quantum weak coin flipping amongst a plurality of participating parties. The protocol allows computation of the exact initial bias and may include determining a number of rounds of exchange in a quantum weak coin flipping algorithm to achieve a predetermined maximum bias value. In turn, quantum weak coin flipping may be performed in a pair-wise fashion amongst all of the plurality of participating parties. A result of each pair-wise quantum weak coin flipping instance may be shared with another of the plurality of participating parties other than the parties participating in generating the result. In turn, the results of each pair-wise quantum weak coin flipping instance may be combined to provide a random value that may be used as a cryptographic key or as a seed to some cryptographic function.

### BACKGROUND

It may be desirable to generate randomness to facilitate improved security and trustworthiness for cryptographic purposes. For example, generating randomness may involve generation of random numbers or random keys that may be used by multiple parties in a shared cryptographic scheme. The randomness of such schemes may allow for secure sharing without any one party being capable of manipulating the scheme to obtain unauthorized access or other advantages relative to other parties. That is, for cryptographic purposes randomness should have sufficiently high entropy to provide strong cryptography for all parties.

However, in distributed systems in which remotely located and unrelated parties coordinate to participate in a cryptographic scheme, the problem of trustworthiness presents difficulty in ensuring no party has advantage over another party. In a distributed setting, it may be desirable to have all parties to participate equally in generating randomness. It may prove difficult to allow for participation by remotely located participants that are not capable of discerning the truthfulness of another party in a distributed system. As such, the problem arises of how to provide randomness in a distributed and trustless environment such that no party participating in a scheme achieves an advantage relative to other parties as then there is no guarantee of achieving the desired entropy for the generated randomness.

### SUMMARY

The present disclosure relates to generation of a random value amongst a plurality of participating parties. This includes determining a number of rounds of communication for a quantum weak coin flipping protocol based on a predetermined acceptable bias value. In turn, a quantum weak coin flipping protocol is performed having the number of rounds of communication between pairs of the plurality of participating parties such that all of the plurality of participating parties performs the quantum weak coin flipping protocol with each of the other plurality of participating parties. A decision from each of the quantum weak coin flipping protocols is generated between the pairs of the plurality of participating parties. Each of the decisions from each of the quantum weak coin flipping protocols is reported to another one of the plurality of participating parties not involved a given paired performance of the quantum weak coin flipping protocol by sharing a quantum system of each party in the given paired performance of the quantum weak coin flipping protocol with the another one of the plurality of participating parties. In turn, each of the decisions from each of the quantum weak coin flipping protocols is saved with every other one of the plurality of participating parties to define a sequence of random decisions comprising the random value.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example of a weak quantum coin flipping protocol.

FIG. 2 illustrates a graphical representation of an example of a plurality of participating parties in a distributed and trustless environment.

FIG. 3 illustrates an example of a first pair-wise weak quantum coin flipping protocol between two of the plurality of participating parties in which a result is shared with the others of the plurality of participating parties.

FIG. 4 illustrates an example of a second pair-wise weak quantum coin flipping protocol between two of the plurality of participating parties in which a result is shared with the others of the plurality of participating parties.

FIG. 5 illustrates an example of the results of each pair-wise weak quantum coin flipping protocol being used to generate a random value.

FIG. 6 illustrates example operations of a protocol according to the present disclosure.

FIG. 7 illustrates a graphical representation of an example of a computing device operative to perform aspects of the present disclosure.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

As noted above, generated randomness (e.g., in the form of a random number or other random string), may be used in cryptography. Specifically, in at least some cryptographic schemes, it may be desired to have a plurality of distributed parties participate equally in generating randomness. In such a distributed environment, the plurality of parties may be remotely located with little or no ability to verify the trustworthiness of the other parties. As such, these distributed system may also be trustless. In such a distributed and trustless setting with a plurality of distributed parties that do not trust each other, it may be desired to have all parties participate equally in generating and refreshing cryptographic keys for a cryptographic scheme. Moreover, the intent of the parties (e.g., whether honest or malicious) may not be known in a manner that allows quantifying the bias of a party. However, presence or absence of bias E may be assumed or even known beforehand without the exact value of ∈.

However, lack of randomness may lead to generation of predictable cryptographic keys. Because it is possible that some of the parties are malicious, the randomness shared by a malicious party may not be of sufficiently large enough entropy, leading to weak encryption. In this scenario a malicious party may introduce bias that allows the malicious party to predict or otherwise surreptitiously obtain cryptographic keys. As such, malicious parties can wreak havoc by exploiting weak encryption to their advantage in distributed and trustless environments.

Many existing blockchain-based protocols have varying mechanisms to support the nodes in generating identical distributed randomness. These mechanisms may be based on established cryptographic primitives such as verifiable delay functions, threshold signatures (e.g., Boneh-Lynn-Shacham (BLS) signatures are used commonly), and verifiable random functions. However, all existing solutions have one or more shortcomings including the fact that they are not quantum-safe (e.g., they are vulnerable to quantum attacks), they assume that a majority of nodes are honest, and/or they are vulnerable to passive attacks such as eavesdroppers. Therefore, generating randomness amongst trustless parties in a distributed system with sufficient entropy to provide a basis for strong cryptography.

Accordingly, the present disclosure relates to a protocol to generate random values (e.g., as cryptographic keys or for use in generating cryptographic keys) in scenarios including a distributed settings wherein some parties are biased during randomness generation. Specifically, the approach provided herein may leverage any quantum weak coin-flipping technique.

Quantum coin-flipping techniques have been proposed to allow for two distributed parties to share a result of a random “coin flip” or selection of a bit value of 0 or 1. Such techniques are corollaries of a random flip of the coin but provide the ability for the parties to participate in such a flip of a coin when the parties are remote and do not trust each other. For example, suppose that Alice and Bob are two mutually mistrusting parties who are aware of each other's biases. Alice and Bob may desire to arrive at a unified decision between two choices, represented as a bit of value 0 or 1. Alice may desire an outcome in which the value of the bit is 0 while Bob may desire an outcome in which the value of the bit is 1. However, neither Alice nor Bob will gain anything from such a protocol unless they can agree on a decision. This scenario presents a situation in which coin flipping may allow Alice and Bob to arrive at a fair (e.g., random) decision. In classical formulations of this scenario, a solution is for Alice and Bob to have a trusted third party flip a coin and report the result. But a problem arises in which coin-flipping is to be performed in the absence of any trusted third party or a common source of randomness.

In purely classical settings with Alice and Bob possessing unlimited computational power, it is provable that achieving a fair coin flip is impossible for this problem—no matter how many rounds Alice and Bob go on for.

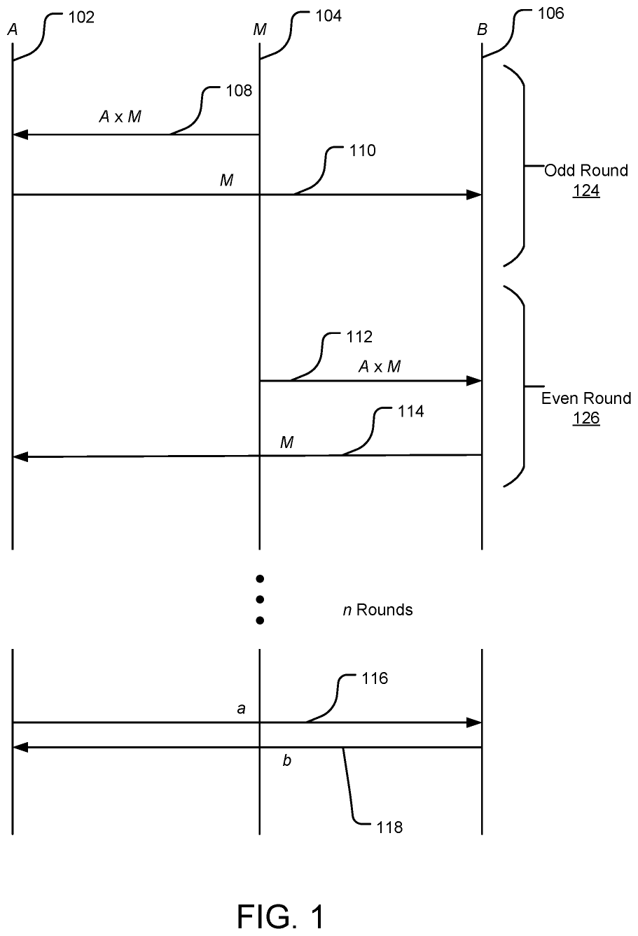

Quantum weak coin-flipping may include a protocol described below and generally illustrated in FIG. 1. Alice may possess or control a quantum system A 102, and Bob may possess or control a quantum system B 106. Note that A 102 and B 106 need not be quantum computers. Rather A 102 and B 106 could be endpoints of a noiseless quantum channel. An additional quantum system M 104 may store quantum messages exchanged between Alice and Bob. Without loss of generality, Alice may possess M 104 initially. During odd numbered rounds 124, Alice performs a joint quantum operation 108 on A and M, after which Alice sends 110 M to Bob. During even numbered rounds 126, Bob performs a joint quantum operation 112 on A and M, after which Bob sends 114 M to Alice. After n rounds, Alice performs a binary measurement on A and shares the output bit 116 a∈{0,1} with Bob. Similarly, Bob performs a binary measurement on B and shares 118 the output bit b∈{0,1}.

In this protocol, one may imagine that both Alice and Bob are biased preferring 0 and 1 outputs, respectively. The biases of both parties may be known to the other. It is also worth mentioning that all existing quantum weak coin flipping protocols require the exact value of the bias to be known beforehand as that information is needed to decide the number of rounds that must be performed to reduce the bias to acceptable levels. A quantum weak coin flipping protocol may be suitable with bias E if the following conditions hold:
If both, Alice and Bob, are honest, then the probability that a and b are either 0 or 1 is ½ (e.g., Pr[a=b=0]=Pr[a=b=1]=½).
If Alice behaves maliciously and Bob behaves honestly, then the probability that the value of b is 0 is less than or equal to a bias value (ϵ)+½ (e.g., Pr[b=0]≤ϵ+½).
If Bob behaves maliciously and Alice behaves honestly, then, then the probability that the value of a is 1 is less than or equal to a bias value (ϵ)+½ (e.g., Pr[a=1]≤ϵ+½).

As such, much development of quantum coin flipping has occurred in an effort to reduce the maximum bias provided by an algorithm. Quantum coin flipping has been formalized such that is has been proven that quantum weak coin flipping can achieve a bias of 0.42 (ϵ=0.42). Through various quantum weak coin flipping algorithms, the maximum value of bias was reduced to a value of

$$ϵ = \frac{\sqrt{2} - 1}{2} .$$

These results involved a small constant number of communication rounds.

Other approaches introduce a family of quantum weak coin flipping protocols that approached a bias value of ϵ≈0.166. Thereafter by using the idea of point games, it has been demonstrated that a family of weak coin flipping protocols may include bias tending to zero. Furthermore, it has been established that any quantum weak coin-flipping protocol desiring a given maximum bias value E must use at least

$$exp ( Ω ( \frac{1}{\sqrt{ϵ}} ) )$$

rounds of communication to achieve the desired bias value of E. As such, for a given quantum weak coin flipping protocol, one may attain any possible value of bias E at the expense of increased communication overhead. In addition, an important advantage of quantum weak coin flipping is that with an assumption of noiseless quantum channels, a quantum weak coin flipping algorithm may be impossible to eavesdrop on due to the no-cloning theory of quantum mechanics.

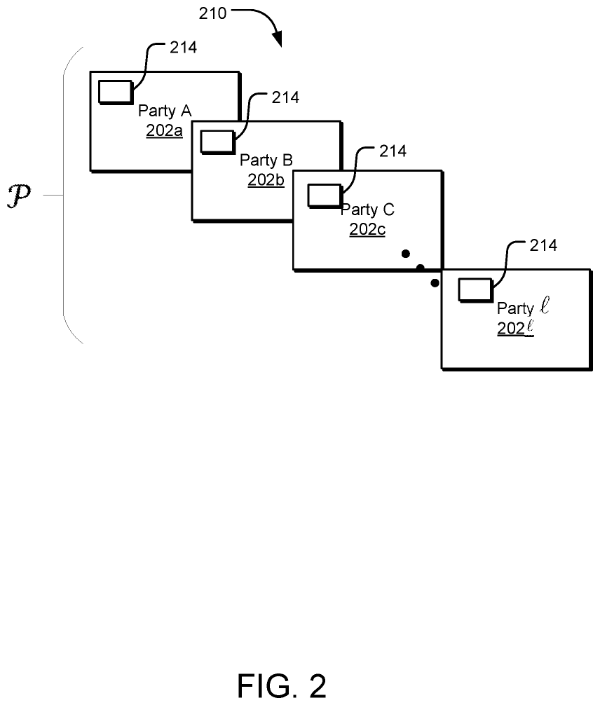

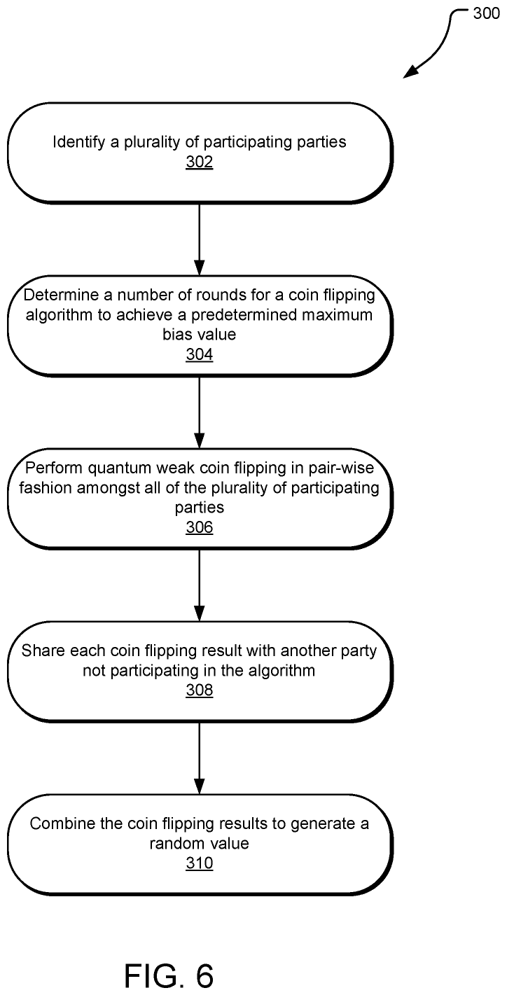

Accordingly, the present disclosure may allow for generation of random keys with high entropy in a truly distributed and trustless setting. With reference to FIG. 6, a flow chart illustrating example operations 300 of a protocol of the present disclosure is presented. Specifically the operations 300 of the preset disclosure may include an identifying operation 302 in which a plurality of parties is identified. The plurality of participating parties may include a set of parties [symbol] = [symbol] , where the set of [symbol] parties that want to participate in the protocol. This is illustrated in FIG. 2 that illustrates a plurality of parties [symbol] 210 that includes Party A 202a, Party B 202b, Party C 202c, . . . , Party [symbol] 202 [symbol] . Each of the plurality of parties [symbol] 210 may also include a quantum system 214 as described above in relation to each of Alice and Bob in connection with performance of a quantum weak coin flipping algorithm.

In addition, the protocol may assume that there is a known subset of biased parties ( [symbol] ′) belonging to the set of parties (i.e., [symbol] ′⊂ [symbol] ) whose members are known to be biased. However, the protocol may not have any information regarding the exact value of the collective bias of the subset of biased parties or individual biases of the parties belonging to the subset of biased parties. Furthermore, the approximate entropy may be used to compute randomness of any bitstring, provided that the following holds in the given setting:

$${min}_{n} \frac{n}{{s}^{m + 1}} > 0 \qquad Equation ( 1 )$$

where n denotes the number of rounds of quantum weak coin flipping, m denotes the number of parties (e.g., m= [symbol] ), and s is the size of alphabet, which for quantum weak coin flipping is 2 (e.g., ({0, 1})). By applying the specific constraints of quantum weak coin flipping, to Equation (1), approximate entropy from quantum weak coin flipping can be calculated when the following holds:

$${min}_{n} \frac{n}{{2}^{ℓ + 1}} > 0 \qquad Equation ( 2 )$$

In one example, for a number of parties where [symbol] =17, the number of rounds required to compute approximate entropy is n=105. Therefore, for appropriate parameters, approximate entropy gives an acceptable measure of the randomness/entropy for bitstrings.

Specifically, a determining operation 304 may be performed in which a predetermined maximum bias value may be provided for determining a number of rounds of quantum weak coin flipping should be performed. This may include computing a current value of bias, which may be used to determine the number of rounds required to get the current value of bias to a predetermined maximum value using Equation (2) above. In this regard the exact value of the initial biases of the parties does not need to be known; instead, it must only be known/assumed which parties are/can-be biased.

The determining operation 304 may be performed at a protocol coordination module that may be hosted at a given one of the participating parties or may be at a protocol organizer separate from any of the parties. The predetermined maximum bias value (ϵ) may be selected by an organizer of the protocol or decided amongst the participating parties. While the predetermined maximum bias value may be greater than zero, the value may be sufficiently small so as to confer assurances to the plurality of participating parties that no one party has sufficient bias to compromise the randomness of the protocol. In this regard, the predetermined maximum bias value ϵ may achieve acceptable levels of bias while keeping the number of rounds under a pre-decided threshold.

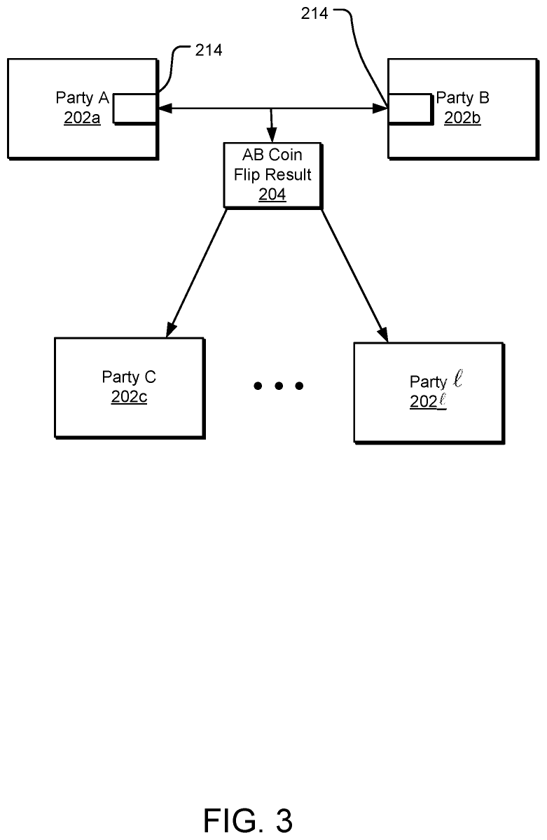

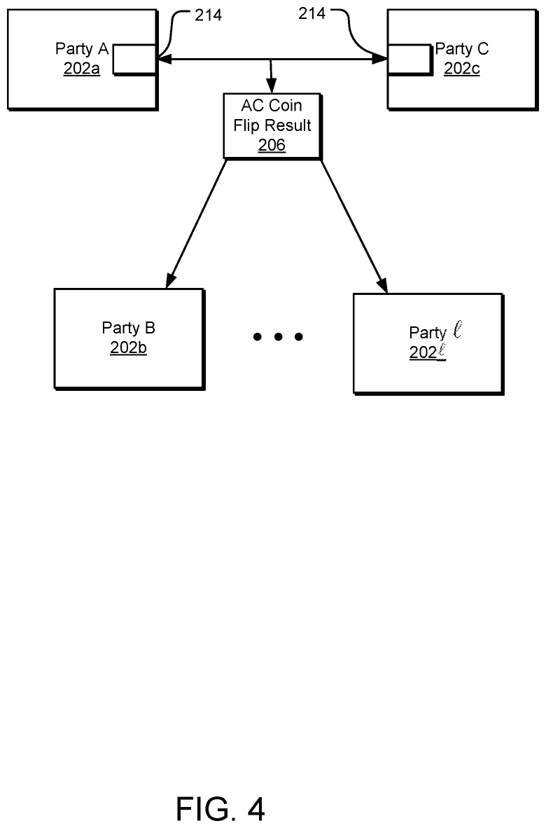

In turn, a performing operation 306 includes each party of the plurality of parties (Pᵢ∈ [symbol] ) participating in quantum weak coin flipping protocol in a pair-wise fashion with all other parties. This may include a quantum weak coin flipping algorithm as described in FIG. 1 performed between respective quantum systems 214 of a pair of participating parties [symbol] 210 with an intermediate system M. One such example of this is shown in FIG. 3, in which Party A 202a and Party B 202b participate in a quantum weak coin flipping algorithm to generate an AB coin flip result 204. Another example of this pair-wise coin flipping is shown in FIG. 4 in which Party A 202a and Party C 202c participate in a quantum weak coin flipping algorithm using respective quantum systems 214 to generate an AC coin flip result 206. While two examples of pair-wise coin flipping are illustrative to demonstrate the generation of a coin flip result, it may be appreciated that all of the plurality of participating parties may participate in pair-wise coin flipping with each other party in the plurality of participating parties.

A sharing operation 308 is provided in which coin flipping results from each pair-wise quantum weak coin flipping instance is shared with another of the plurality of participating parties. Specifically, after running the quantum weak coin flipping with exactly one other party (Pⱼ), each of the plurality of participating parties (Pᵢ∈ [symbol] ) shares its quantum system M with another party of the plurality of participating parties (Pᵢ∈ [symbol] ) other than the party with which the participating party Pᵢ performed the quantum weak coin flipping (e.g., Pⱼ≠P_{z}). This sharing ensures that the decision between Pᵢ and Pⱼ is shared—as part of M—with P_{z}. Thus, as illustrated in FIGS. 3 and 4, the AB coin flip result 204 may be shared with another party other than Party A 202a and Party B 202b and the AC coin flip result 206 may be shared with another party other than Party A 202a and Party C 202c. The steps of running the quantum weak coin flipping with exactly one other party may be repeated by all of the plurality of participating parties (Pᵢ∈ [symbol] (i∈[ [symbol] ])) until each of the plurality of participating parties has performed quantum weak coin flipping with all other parties in the plurality of participating parties [symbol] and shared the result of the quatnum weak coin flipping. In this example, the decision of each quantum weak coin flipping may be shared as part of sharing a shared quantum system M resulting from the quantum weak coin flipping.

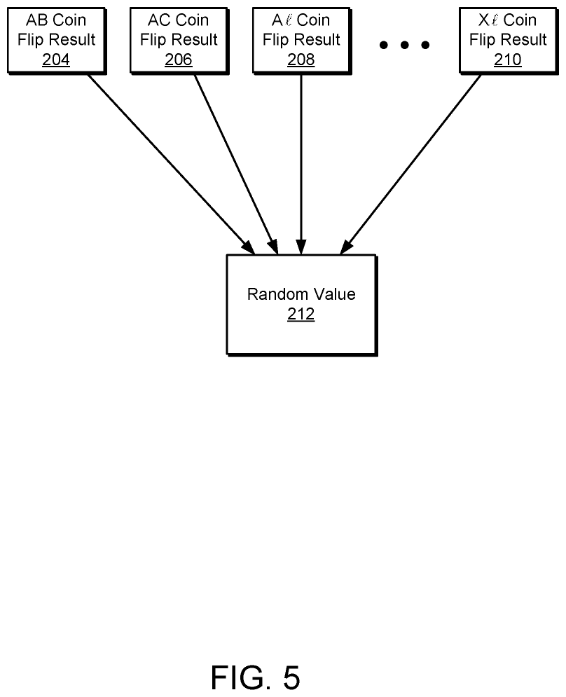

As such, a combining operation 310 may be performed in which the coin flipping results are combined into a random value. For instance, each party shares the decision c∈{0, 1} of its pairwise quantum weak coin flipping with every other party in the plurality of participating parties [symbol] . This is illustrated in FIG. 5 in which all coin flip results (represented graphically by the AB coin flip result 204, the AC coin flip result 206, an A [symbol] coin flip result 208, . . . , an X [symbol] coin flip result 210 where the X [symbol] coin flip result 210 represents the last of each pair-wise combination of the plurality of parties [symbol] . In one example, the coin flip results 204-210 may be shared via a noiseless quantum channel. Because the quantum channels are noiseless, each party may receive the same sequence, S, of random decisions from the pair-wise quantum weak coin flipping performed between each combination of the plurality of parties. Thus, the sequence S of random decisions may comprise a random value 212. In addition, for a cryptographic hash function (H) and a random string r∈ [symbol] , each party may compute:

ϵ=log(ApEn(H(r))−ApEn(S))

where ApEn(x) denotes approximate entropy of x. If the value of ϵ is acceptable, then the protocol may cease, and the value of the sequence S is accepted. If ϵ is not acceptable, the protocol may be repeated with more rounds n of the quantum weak coin flipping occurring.

Furthermore, as noted above, it has been shown that the number of rounds of a quantum weak coin flipping algorithm to reduce bias to a desired value of ϵ is

$$exp ( Ω ( \frac{1}{\sqrt{ϵ}} ) .$$

Accordingly, the minimum number of rounds required for the protocol described herein is:

$$n = max ( ( {min}_{n} \frac{n}{{s}^{m + 1}} > 0 ) , min ( exp ( Ω ( \frac{1}{\sqrt{ϵ}} ) ) )$$

In an example, the plurality of participating parties may use the random value 212 as an encryption key. Alternatively, the random value 212 may be used as an input as a seed to any cryptographic key expansion function and derive key(s). For example, the random value 212 may be used as an input to a key generation/derivation function, a keyed hash function, or a (key-homomorphic) pseudorandom function family.

The protocol described herein may exhibit some specific characteristics that are advantageous for generating randomness in a distributed and trustless environment. For example, the protocol described herein protocol may support distributed randomness/key generation in the presence of a malicious-majority. That is, even if a majority of the plurality of participating parties are malicious and attempt to inject bias into the randomness, the presently disclosed protocol may limit such bias to the predetermined maximum bias value E even in the presence of a majority of parties attempting to maliciously influence the protocol. Furthermore, the protocol may be protective against both passive attacks (e.g., eavesdropping) and quantum algorithms. In this regard, the protocol may provide information-theoretic security. Finally, unlike the existing quantum weak coin flipping protocols, the presented protocol does not require prior knowledge the exact value of the bias.

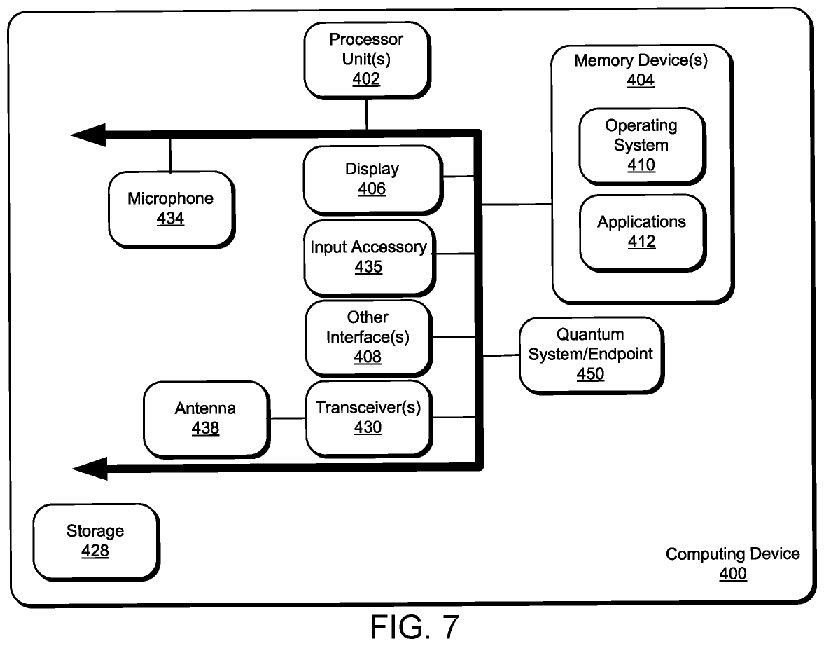

FIG. 7 illustrates an example schematic of a computing device 400 suitable for implementing aspects of the disclosed technology including a quantum system or quantum endpoint 450 as described above. The computing device 400 includes one or more processor unit(s) 402, memory 404, a display 406, and other interfaces 408 (e.g., buttons). The memory 404 generally includes both volatile memory (e.g., RAM) and non-volatile memory (e.g., flash memory). An operating system 410, such as the Microsoft Windows® operating system, the Apple macOS operating system, or the Linux operating system, resides in the memory 404 and is executed by the processor unit(s) 402, although it should be understood that other operating systems may be employed.

One or more applications 412 are loaded in the memory 404 and executed on the operating system 410 by the processor unit(s) 402. Applications 412 may receive input from various input local devices such as a microphone 434, input accessory 435 (e.g., keypad, mouse, stylus, touchpad, joystick, instrument mounted input, or the like). Additionally, the applications 412 may receive input from one or more remote devices such as remotely-located smart devices by communicating with such devices over a wired or wireless network using more communication transceivers 430 and an antenna 438 to provide network connectivity (e.g., a mobile phone network, Wi-Fi®, Bluetooth®). The computing device 400 may also include various other components, such as a positioning system (e.g., a global positioning satellite transceiver), one or more accelerometers, one or more cameras, an audio interface (e.g., the microphone 434, an audio amplifier and speaker and/or audio jack), and storage devices 428. Other configurations may also be employed.

The computing device 400 further includes a power supply 416, which is powered by one or more batteries or other power sources, and which provides power to other components of the computing device 400. The power supply 416 may also be connected to an external power source (not shown) that overrides or recharges the built-in batteries or other power sources.

In an example implementation, the computing device 400 comprises hardware and/or software embodied by instructions stored in the memory 404 and/or the storage devices 428 and processed by the processor unit(s) 402. The memory 404 may be the memory of a host device or of an accessory that couples to the host. Additionally or alternatively, the computing device 400 may comprise one or more field programmable gate arrays (FGPAs), application specific integrated circuits (ASIC), or other hardware/software/firmware capable of providing the functionality described herein.

The computing device 400 may include a variety of tangible processor-readable storage media and intangible processor-readable communication signals. Tangible processor-readable storage can be embodied by any available media that can be accessed by the computing device 400 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the computing device 400. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

One general aspect of the present disclosure includes a method for generation of a random value amongst a plurality of participating parties. The method includes determining a number of rounds of communication for a quantum weak coin flipping protocol based on a predetermined acceptable bias value. The method also includes performing the quantum weak coin flipping protocol having the number of rounds of communication between pairs of the plurality of participating parties such that all of the plurality of participating parties performs the quantum weak coin flipping protocol with each of the other plurality of participating parties. The method includes generating a decision from each of the quantum weak coin flipping protocols between the pairs of the plurality of participating parties and reporting each of the decisions from each of the quantum weak coin flipping protocols to another one of the plurality of participating parties not involved a given paired performance of the quantum weak coin flipping protocol by sharing a quantum system of each party in the given paired performance of the quantum weak coin flipping protocol with the another one of the plurality of participating parties. The method further includes saving each of the decisions from each of the quantum weak coin flipping protocols with every other one of the plurality of participating parties to define a sequence of random decisions comprising the random value.

Implementations may include one or more of the following features. For example, the method may also include computing an initial value of biases of the plurality of participating parties.

In an example, the decisions of each of the quantum weak coin flipping protocols may be shared with the other ones of the plurality of participating parties using a noiseless quantum channel.

In an example, the weak quantum coin flipping may include maintaining a quantum system at each of the plurality of participating parties and providing an additional quantum system for storage of quantum messages exchanged between respective ones of the plurality of participating parties. The weak quantum coin flipping may further include performing a first joint quantum operation using a first quantum system of a first party and the additional quantum system to generate a first quantum operation result, sending the first joint quantum operation to a second party of the plurality of participating parties, performing a second joint quantum operation using a second quantum system of the second party on the first quantum operation result, and sending the additional quantum system to the first party The weak quantum coin flipping may include performing a measurement on the first quantum system by the first party and the second quantum system by the second party and sharing output bits of each respective one of the measurements with the other party.

In an example, the random value may be a random key used in a cryptographic scheme. In another example, the random value may be a seed to a cryptographic key expansion function to derive a cryptographic key.

In an example, the random value exhibits a bias equal to or less than the predetermined acceptable bias value in the presence of a malicious majority of the plurality of participating parties. Furthermore, the method may be quantum-safe.

Another general aspect of the present disclosure includes a system for use in generation of a random value amongst a plurality of participating parties. The system includes a protocol organization module operative to determine a number of rounds of communication for a quantum weak coin flipping protocol based on a predetermined acceptable bias value. The system also includes at least a first party comprising a quantum system for performing the quantum weak coin flipping protocol having the number of rounds of communication with another of the plurality of participating parties to generate a decision. The first party performs the quantum weak coin flipping protocol with each of the other plurality of participating parties to generate the decision for each pair-wise performance of the quantum weak coin flipping protocol. In turn, the first party shares each decision from each of the quantum weak coin flipping protocols to another one of the plurality of participating parties not involved a given paired performance of the quantum weak coin flipping protocol by sharing a quantum system with the another one of the plurality of participating parties. Each of the decisions from each of the quantum weak coin flipping protocols with every other one of the plurality of participating parties to define a sequence of random decisions comprising the random value.

Implementations may include one or more of the following features. For example, the protocol organization module may also compute an initial value of biases of the plurality of participating parties.

In an example, the decisions of each of the quantum weak coin flipping protocols may be shared with the other ones of the plurality of participating parties using a noiseless quantum channel.

In an example, the quantum system may be operative to perform a first joint quantum operation with an additional quantum system to generate a first quantum operation result, send the first joint quantum operation to a second party of the plurality of participating parties that performs a second joint quantum operation using a second quantum system of the second party on the first quantum operation result, and receive the additional quantum system. In turn, the quantum system may perform a measurement on the first quantum system and share output bits of the measurement with the other party.

In an example, the random value may be a random key used in a cryptographic scheme. In another example, the random value may be a seed to a cryptographic key expansion function to derive a cryptographic key.

In an example, the random value exhibits a bias equal to or less than the predetermined acceptable bias value in the presence of a malicious majority of the plurality of participating parties. Furthermore, the method may be quantum-safe.

Another general aspect of the present disclosure includes one or more tangible processor-readable storage media embodied with instructions for executing on one or more processors and circuits of a device a process for generation of a random value amongst a plurality of participating parties. The process includes determining a number of rounds of communication for a quantum weak coin flipping protocol based on a predetermined acceptable bias value and performing the quantum weak coin flipping protocol having the number of rounds of communication between pairs of the plurality of participating parties such that all of the plurality of participating parties performs the quantum weak coin flipping protocol with each of the other plurality of participating parties. The process also includes generating a decision from each of the quantum weak coin flipping protocols between the pairs of the plurality of participating parties and reporting each of the decisions from each of the quantum weak coin flipping protocols to another one of the plurality of participating parties not involved a given paired performance of the quantum weak coin flipping protocol by sharing a quantum system of each party in the given paired performance of the quantum weak coin flipping protocol with the another one of the plurality of participating parties. The process also includes saving each of the decisions from each of the quantum weak coin flipping protocols with every other one of the plurality of participating parties to define a sequence of random decisions comprising the random value.

Implementations may include one or more of the following features. For example, the process may also include computing an initial value of biases of the plurality of participating parties.

In an example, the decisions of each of the quantum weak coin flipping protocols may be shared with the other ones of the plurality of participating parties using a noiseless quantum channel.

In an example, the weak quantum coin flipping may include maintaining a quantum system at each of the plurality of participating parties and providing an additional quantum system for storage of quantum messages exchanged between respective ones of the plurality of participating parties. The weak quantum coin flipping may further include performing a first joint quantum operation using a first quantum system of a first party and the additional quantum system to generate a first quantum operation result, sending the first joint quantum operation to a second party of the plurality of participating parties, performing a second joint quantum operation using a second quantum system of the second party on the first quantum operation result, and sending the additional quantum system to the first party The weak quantum coin flipping may include performing a measurement on the first quantum system by the first party and the second quantum system by the second party and sharing output bits of each respective one of the measurements with the other party.

In an example, the random value may be a random key used in a cryptographic scheme. In another example, the random value may be a seed to a cryptographic key expansion function to derive a cryptographic key.

In an example, the random value exhibits a bias equal to or less than the predetermined acceptable bias value in the presence of a malicious majority of the plurality of participating parties. Furthermore, the method may be quantum-safe.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A method for generation of a random value amongst a plurality of participating parties, the method comprising:
determining a number of rounds of communication for a quantum weak coin flipping protocol based on a predetermined acceptable bias value;
performing the quantum weak coin flipping protocol having the number of rounds of communication between pairs of the plurality of participating parties such that all of the plurality of participating parties performs the quantum weak coin flipping protocol with each of the other plurality of participating parties;
generating a decision from each of the quantum weak coin flipping protocols between the pairs of the plurality of participating parties;
reporting each of the decisions from each of the quantum weak coin flipping protocols to another one of the plurality of participating parties not involved a given paired performance of the quantum weak coin flipping protocol by sharing a quantum system of each party in the given paired performance of the quantum weak coin flipping protocol with the another one of the plurality of participating parties; and
saving each of the decisions from each of the quantum weak coin flipping protocols with every other one of the plurality of participating parties to define a sequence of random decisions comprising the random value.

2. The method of claim 1, further comprising:
computing an initial value of biases of the plurality of participating parties.

3. The method of claim 1, wherein the decisions of each of the quantum weak coin flipping protocols are shared with the other ones of the plurality of participating parties using a noiseless quantum channel.

4. The method of claim 1, wherein the weak quantum coin flipping comprises:
maintaining a quantum system at each of the plurality of participating parties;
providing an additional quantum system for storage of quantum messages exchanged between respective ones of the plurality of participating parties;
performing a first joint quantum operation using a first quantum system of a first party and the additional quantum system to generate a first quantum operation result;
sending the first joint quantum operation to a second party of the plurality of participating parties;
performing a second joint quantum operation using a second quantum system of the second party on the first quantum operation result;
sending the additional quantum system to the first party; and
performing a measurement on the first quantum system by the first party and the second quantum system by the second party; and
sharing output bits of each respective one of the measurements with the other party.

5. The method of claim 1, wherein the random value comprise a random key used in a cryptographic scheme.

6. The method of claim 1, wherein the random value comprises a seed to a cryptographic key expansion function to derive a cryptographic key.

7. The method of claim 1, wherein the random value exhibits a bias equal to or less than the predetermined acceptable bias value in the presence of a malicious majority of the plurality of participating parties.

8. The method of claim 1, wherein the method is quantum-safe.

9. A system for use in generation of a random value amongst a plurality of participating parties, the system comprising:
a protocol organization module operative to determine a number of rounds of communication for a quantum weak coin flipping protocol based on a predetermined acceptable bias value;
at least a first party comprising a quantum system for performing the quantum weak coin flipping protocol having the number of rounds of communication with another of the plurality of participating parties to generate a decision, wherein the first party performs the quantum weak coin flipping protocol with each of the other plurality of participating parties to generate the decision for each pair-wise performance of the quantum weak coin flipping protocol, and wherein the first party shares each decision from each of the quantum weak coin flipping protocols to another one of the plurality of participating parties not involved a given paired performance of the quantum weak coin flipping protocol by sharing a quantum system with the another one of the plurality of participating parties;
wherein each of the decisions from each of the quantum weak coin flipping protocols with every other one of the plurality of participating parties to define a sequence of random decisions comprising the random value.

10. The system of claim 9, wherein the protocol organization module further computes an initial value of biases of the plurality of participating parties.

11. The system of claim 9, wherein the decisions of each of the quantum weak coin flipping protocols are shared with the other ones of the plurality of participating parties using a noiseless quantum channel.

12. The system of claim 9, wherein the quantum system is operative to:
perform a first joint quantum operation with an additional quantum system to generate a first quantum operation result;
send the first joint quantum operation to a second party of the plurality of participating parties that performs a second joint quantum operation using a second quantum system of the second party on the first quantum operation result;
receive the additional quantum system;
perform a measurement on the first quantum system; and
share output bits of the measurement with the other party.

13. The system of claim 9, wherein the random value comprise a random key used in a cryptographic scheme.

14. The system of claim 9, wherein the random value comprises a seed to a cryptographic key expansion function to derive a cryptographic key.

15. The system of claim 9, wherein the random value exhibits a bias equal to or less than the predetermined acceptable bias value in the presence of a malicious majority of the plurality of participating parties.

16. The system of claim 9, wherein the method is quantum-safe.

17. One or more tangible processor-readable storage media embodied with instructions for executing on one or more processors and circuits of a device a process for generation of a random value amongst a plurality of participating parties, the process comprising:
determining a number of rounds of communication for a quantum weak coin flipping protocol based on a predetermined acceptable bias value;
performing the quantum weak coin flipping protocol having the number of rounds of communication between pairs of the plurality of participating parties such that all of the plurality of participating parties performs the quantum weak coin flipping protocol with each of the other plurality of participating parties;
generating a decision from each of the quantum weak coin flipping protocols between the pairs of the plurality of participating parties;
reporting each of the decisions from each of the quantum weak coin flipping protocols to another one of the plurality of participating parties not involved a given paired performance of the quantum weak coin flipping protocol by sharing a quantum system of each party in the given paired performance of the quantum weak coin flipping protocol with the another one of the plurality of participating parties; and
saving each of the decisions from each of the quantum weak coin flipping protocols with every other one of the plurality of participating parties to define a sequence of random decisions comprising the random value.

18. The one or more tangible processor-readable storage media of claim 17, wherein the process further comprises:
computing an initial value of biases of the plurality of participating parties.

19. The one or more tangible processor-readable storage media of claim 17, wherein the decisions of each of the quantum weak coin flipping protocols are shared with the other ones of the plurality of participating parties using a noiseless quantum channel.

20. The one or more tangible processor-readable storage media of claim 17, wherein the weak quantum coin flipping comprises:
maintaining a quantum system at each of the plurality of participating parties;
providing an additional quantum system for storage of quantum messages exchanged between respective ones of the plurality of participating parties;
performing a first joint quantum operation using a first quantum system of a first party and the additional quantum system to generate a first quantum operation result;
sending the first joint quantum operation to a second party of the plurality of participating parties;
performing a second joint quantum operation using a second quantum system of the second party on the first quantum operation result;
sending the additional quantum system to the first party; and
performing a measurement on the first quantum system by the first party and the second quantum system by the second party; and
sharing output bits of each respective one of the measurements with the other party.

21. The one or more tangible processor-readable storage media of claim 17, wherein the random value comprise a random key used in a cryptographic scheme.

22. The one or more tangible processor-readable storage media of claim 17, wherein the random value comprises a seed to a cryptographic key expansion function to derive a cryptographic key.

23. The one or more tangible processor-readable storage media of claim 17, wherein the random value exhibits a bias equal to or less than the predetermined acceptable bias value in the presence of a malicious majority of the plurality of participating parties.
